(19) United States
(12) Patent Application Publication
(10) Pub. No.: US 2004/0172284 A1
(43) Pub. Date: Sep. 2, 2004

(54) Information management system

(75) Inventors: John R. Sullivan, Carmel, IN (US); Richard Ranucci, Indianapolis, IN (US); Thomas DiBella, Carmel, IN (US)

Correspondence Address: BOSE MCKINNEY & EVANS LLP, 135 N PENNSYLVANIA ST, SUITE 2700, INDIANAPOLIS, IN, 46204, US

(73) Assignee: Roche Diagnostics Corporation

(21) Appl. No.: 10/366,175

(22) Filed: Feb. 13, 2003

(51) Int. Cl. G06F 17/60

(52) U.S. Cl. 705/2

(57) ABSTRACT

A system and method for managing information in a healthcare facility includes the steps of uploading information to a server, notifying a physician that the information is available for review, receiving a message from the server verifying that the information was reviewed by the physician, acknowledging receipt of the message, and automatically updating a file documenting the uploading, receiving, and acknowledging steps.

### FIELD OF THE INVENTION

The present invention relates generally to systems and methods for managing information in a healthcare facility, and more particularly to a system and method wherein such information is obtained or entered, uploaded by a first computer to a server via a network, and reviewed by a physician using a second computer after receiving notification that the information is available, the server providing a message to the first computer verifying that the information was reviewed which, when acknowledged, causes the system to automatically update a file documenting the information review procedure.

### BACKGROUND OF THE INVENTION

The various tasks demanding the attention of healthcare providers during the course of a typical workday are at best, challenging, and at worst, overwhelming. It is widely believed that many healthcare providers, even in fully staffed facilities, are simply unable to provide an optimal level of care because, for primarily economic reasons, they are required to care for too many patients. Such high patient loads not only decrease the time available for each patient, they increase the total administrative time associated with healthcare delivery. Of course, it is even more difficult for under-staffed facilities to achieve their goal of delivering high quality healthcare. To make matters worse, facilities that fail to meet this goal also face an increased risk of liability for damages resulting from sub-standard care giving, faulty record keeping, and other manifestations of an over-worked staff. Accordingly, it is generally desirable to reduce the time burden on healthcare providers for anything other than directly attending to the needs of patients.

In many facilities, much of the above-mentioned time burden is attributable to administrative tasks, such as information management. This is true, for example, for healthcare facilities that provide services to diabetic patients who require frequent blood glucose (bG) tests to effectively manage the disease. It is well known that a healthy diet, exercise, bG testing, and administration of medication and insulin are the basic diabetes management tools. In healthcare facilities having a high percentage of diabetic patients, daily monitoring of patient bG levels and the associated information management tasks may account for a large portion of a staff's available time. Since diabetes is more common in elderly patients, it is not surprising that healthcare providers in long term care facilities (LTCs), such as nursing homes, experience particularly heavy administrative burdens associated with bG testing.

In addition to the standard record-keeping needed to adequately document a diabetes treatment regimen to provide quality disease management and minimize the LTC's risk of liability, healthcare providers in LTCs must also satisfy the Medicare Part B processing requirements relating specifically to CPT Code 82962 and Medicare Program Memorandum AB-00-108 for the LTCs to obtain government reimbursement for bG testing. To obtain such reimbursement, a healthcare provider must perform a bG test and communicate the results to the physician treating the patient, many of whom are located off-site and receive no additional compensation for daily bG data review. The provider must secure verification that the physician received and reviewed the data. Also, the provider must obtain from the physician instructions for the next test and/or step in the patient's management regimen, even if the next step is simply a continuation of the existing regimen. No standing orders are permitted. Each reported and reviewed test must have been preceded by an order for that test and must be followed by an order for continuation of or a modification to the patient's care (including changes to insulin administration). The provider must generate documentation for each step in this process in order for the LTC to obtain reimbursement for the completed test, regardless of whether the test results indicate that the patient's bG levels are in control or out of control.

Since many LTCs operate under tight budget constraints, these government reimbursements are not inconsequential. This is particularly true for facilities having large populations of diabetic patients, many of whom require multiple bG tests each day. Unfortunately, LTCs having the highest percentages of diabetic patients and the greatest economic need for government reimbursements, are also frequently under-staffed and/or experience high turnover of staff, particularly nurses who are in short supply industry-wide. Whether this phenomenon is a result of the unique challenges of caring for the elderly, the economic challenges of hiring and retaining qualified healthcare providers on a budget that relies on government reimbursements, or a combination of both, healthcare providers in LTCs would benefit greatly from a more automated approach to managing physiological testing information, particularly bG data.

The conventional approach to bG testing information management is time-consuming and subject to human error. Healthcare providers typically document bG test results by hand, and then fax a copy of the handwritten results to the office of the treating physician. Next, the healthcare provider may be required to contact the physician's office by telephone to request that the physician review the data and provide instructions for a subsequent step in the treatment regimen. Often, follow-up telephone calls are required. If the physician faxes back verification that the data was reviewed, along with instructions for a subsequent step, then the verification and instructions must be routed to the appropriate physical file for storage along with the original test results and documentation of submission of those results. If, on the other hand, the physician provides verification and instructions by telephone, then the healthcare provider must generate notes of the conversation, and either transmit the notes back to the physician (by fax or mail) for a signature, or retrieve the notes at a later date when the physician in is the facility, locate the physician, and obtain a signature. In either case, the complete set of documentation must be maintained in a physical file for government audit purposes, and manually transferred to a Medicare form to obtain reimbursement.

This cumbersome process often leads to a failure to document all diagnostic transactions, resulting in lost revenue, damaged reputation, and citations of the LTC in state healthcare surveys. Consequently, some LTCs may reduce the quantity of bG tests performed, thereby simultaneously reducing their administrative burdens and the number of tests that go undocumented. Of course, reduced testing also denies the patients the level of care they would otherwise receive in an alternative setting.

A related documentation task also adds to the administrative burden on healthcare providers. Pursuant to certain federal and state regulations, facilities such as LTCs must report to a treating physician and document in a patient's file the occurrence of a variety of different types of events relating to the patient such as injuries, accidents, reactions to medication, changes in behavior, etc. (collectively referred to as incidents). The goal of these requirements is to ensure quality healthcare for the patients by requiring open disclosure and documentation of incidents that may affect the level of healthcare delivered by the LTC or indicate aspects of the care giving that may be improved.

While the above-described reporting requirements are designed to enhance the quality of life provided by LTCs, these requirements also have unintended and, in some instances, counter-productive consequences. The regulations fail to clearly define the types of incidents that must be reported. Without clear guidelines, LTC administrators cannot effectively decide which incidents to report. As a result, many administrators over-report, unnecessarily documenting insignificant incidents in a conservative effort to comply with the regulations and avoid possible liability for failure to comply. This unnecessary documentation increases the administrative burden of the healthcare providers, thereby decreasing the time available for care giving. Moreover, treating physicians who are responsible for reviewing and responding to incident reports (again, without additional compensation), are also unnecessarily interrupted by insignificant incident reports.

This situation is further complicated by the spontaneous nature of incidents. Unlike routine bG testing, incidents such as patient injuries and accidents are not planned. Healthcare providers cannot schedule time for reporting such incidents. Thus, the administrative task of reporting an incident may constitute an interruption to the provider's otherwise efficiently planned day. Unfortunately, without more clearly articulated reporting requirements, conservative incident reporting will remain standard operating procedure, and healthcare providers and physicians will simply have to perform the required administrative tasks as efficiently as possible.

Presently, incidents are generally considered either “urgent” (incidents involving patient injury) or “routine” (all other reported incidents). For obvious reasons, urgent incidents are reported promptly to treating physicians, who generally are likewise quick to acknowledge receipt of the incident report, review the details relating to the incident, and respond with instructions (if any) for handling the incident. Routine incidents may be reported and documented as time permits. In either situation, the healthcare provider must manually complete the paperwork documenting the incident, forward the paperwork to the treating physician, verify that the incident details have been reviewed, and obtain instructions (if any) for treating the injury resulting from the incident or taking other actions to address the incident and/or prevent further occurrences.

As is the case with conventional methods for managing physiological testing information, current methods for reporting and documenting incidents, regardless of their severity, include generating handwritten notes, making telephone calls to treating physicians, faxing incident reports, and making follow-up calls to physicians to obtain verification of review and instructions. All of this activity reduces the time available for healthcare providers and physicians to care for patients.

### SUMMARY OF THE INVENTION

According to one embodiment, the present invention provides a system and method for managing physiological testing information in a healthcare facility that includes the steps of uploading test data to a server, notifying a physician that the test is complete, receiving a message from the server verifying that the data was reviewed by the physician, acknowledging receipt of the message, and automatically updating a reimbursement file documenting the uploading, receiving, and acknowledging steps for submission to an entity for reimbursement of an expense associated with performing the test.

According to another embodiment, the present invention provides a system and method for managing incident information in a healthcare facility that includes the steps of uploading an incident report to a server, notifying a physician that the report is awaiting review, receiving a message from the server verifying that the report was reviewed by the physician, acknowledging receipt of the message, and automatically updating an incident log documenting the uploading, receiving, and acknowledging steps.

By providing an automated system for documenting physiological testing information and/or incident reports, the present invention may reduce the administrative burden on healthcare providers and the frustrations associated therewith, improve the accuracy of the documentation, increase the revenue of facilities seeking Medicare reimbursements, and improve the quality of patient care by enabling more direct care giving, encouraging optimum testing, and streamlining the review of and response to incidents affecting the health and well-being of patients.

These and other features of the present invention will become more apparent and the invention will be better understood upon review of the following description of embodiments of the invention and the accompanying drawings.

### BRIEF DESCRIPTION OF THE DRAWING

FIG. 1 is a conceptual diagram of components of a system according to the present invention.

FIGS. 2-12 are screen shots generated by software according to the present invention.

FIG. 13 is a reimbursement form generated by software according to the present invention.

### DETAILED DESCRIPTION OF EMBODIMENTS OF THE INVENTION

The embodiments described below are merely exemplary and are not intended to limit the invention to the precise forms disclosed. Instead, the embodiments were selected for description to enable one of ordinary skill in the art to practice the invention. It should be understood that the teachings of the present invention are applicable to management of a variety of different types of information, in a variety of healthcare settings. The applications of the invention described below to bG testing and incident reports in an LTC simply facilitate description of the various features of the invention. These examples provide context and simplify the description of the invention, but do not limit its applications or the scope of the appended claims.

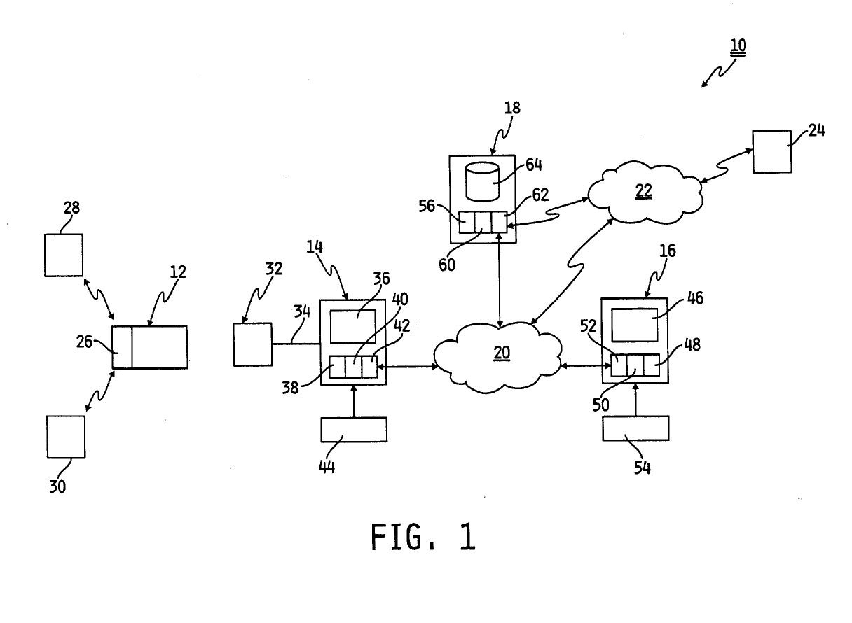

Referring now to FIG. 1, a system 10 for managing physiological testing information according to one embodiment of the present invention generally includes an electronic medical device 12, a first computing device 14, a second computing device 16, a server 18, a first network 20, a second network 22, and a communication module 24. In the example described herein, electronic medical device 12 is a bG meter configured for use by a healthcare provider (hereinafter, a clinician) in performing bG tests on multiple patients, computing the results of the individual tests, and storing the results temporarily. An example of a suitable electronic medical device 12 is an ACCU-CHEK® Inform Professional Blood Glucose Device. According to one embodiment of the invention, device 12 includes a conventional bar code reader 26 for scanning clinician identification information and patient identification information from a clinician identification tag 28 and a patient identification tag 30, respectively. It should be understood, however, that reader 26 may readily be replaced by a variety of different types of input devices for obtaining such identification information such as devices employing IR, active or passive RFID, or other similar technologies. Likewise, tags 28, 30 may readily be replaced with tags or badges employing corresponding technologies for storing and transmitting identification information. In the embodiment described herein, tag 28 is a bar code label affixed in a conventional manner to a clinician identification badge worn by a clinician performing the bG test. Similarly, tag 30 is a bar code label that may be affixed in a conventional manner to a patient identification wristband worn by the patient to be tested, affixed to a location in or near the patient's room, or otherwise associated with the patient.

Device 12 is further configured for coupling to a docking station 32, such as an ACCU-CHEK® Inform Base Unit. As shown, docking station 32 is coupled to first computing device 14 via wire(s) or cable(s) 34. As will be further described below, docking station is configured to receive bG data (along with other testing information) from device 12 and to transfer that data to first computing device 14. It should be understood by one skilled in the art that docking station 32 could readily be replaced with another type of input device that does not require physical contact with device 12 and/or first computing device 14. For example, docking station 32 may include an IR receiver for receiving bG data from device 12 (where device 12 is equipped with an IR transmitter), and an IR transmitter for transmitting the data to first computing device 14 (where first computing device 14 is equipped with an IR input port). Other conventional communications and data transfer technologies, such as optical or RF technologies, may also be employed.

First computing device 14 includes a display 36, a processor 38, a memory 40, a communication device 42, and an input device 44 such as a keyboard, mouse, touch screen, or other conventional input device (or any combination thereof). First computing device 14 may be a conventional personal computer (PC) having sufficient processing, storage, and communications capabilities to perform the various functions described herein. Alternatively, first computing device 14 may be configured as a thin-client type device with minimal processing and storage capability. In any event, first computing device 14 (and docking station 32) may be situated in a location of the LTC that is accessible by a plurality of clinicians, such as a central nurse station or other common location. In the example described below, first computing device 14 is described as a conventional PC.

As shown in FIG. 1, communication device 42 of first computing device 14 is coupled to network 20, which is coupled to network 22. It should be understood that the communications functions of either or both of networks 20, 22 may be performed by any of a variety of different types of networks, including the Internet, the POTS network, a cellular network, a LAN, WAN, voice-over IP, or other network enabling the transfer of information between two or more computing devices. Moreover, while network 20 and network 22 are shown as separate networks in FIG. 1, it should be understood that a single network, or more than two networks, may be employed consistent with the teachings of the present invention. In the example described below, network 20 is the Internet, network 22 is a conventional cellular communications network, and communications device 42 is a modem. In such an embodiment, communications device 42 communicates with network 20 using web browser software stored in memory 40 and executed by processor 38 of first computing device 14. As described below, network 20 is coupled to server 18, which is configured to communicate with first computing device 14 via network 20, communicate with communication module 24 via network 20 and network 22 according to well known principles in the art, and communicate with communication module 24 via network 22 alone.

Second computing device 16 may share certain characteristics with first computing device 14, including a display 46, a processor 48, a memory 50, a communications device 52, and an input device 54. Of course, second computing device 16 may also differ substantially from first computing device 14 in terms of its capabilities and physical configuration. In the example described below, second computing device 16, like first computing device 14, is described as a conventional PC. In one embodiment of the invention, second computing device 16 is located remotely from first computing device 14 in an office of a physician off-site from the LTC. Alternatively, second computing device 16 may be located within the LTC, at the physician's home, or at some other location accessible by the physician responsible for reviewing bG data resulting from tests performed at the LTC.

Referring still to FIG. 1, server 18 may be a conventional server computer including a processor 56, a memory 60, a communications device 62, and a database 64, which may or may not be a component of memory 60. In the example described below, server 18 is configured to generate a plurality of web page interfaces according to principle that are well-known in the art for access by a clinician operating first computing device 14 and a physician operating second computing device 16. Also, database 64 is described herein as a single, centrally accessible data repository for bG data (and other testing information associated with the bG data). As will be apparent to one of ordinary skill in the art, database 64 may alternatively be a distributed database, maintained by multiple servers at multiple physical locations.

Communication module 24 is coupled to network 22 as shown in FIG. 1. As will be apparent upon review of the following description, communication module 24 may include any of a variety of different types of communication devices capable of receiving messages from first computing device 14 via network 22 (and/or network 20, depending upon the configuration of system 10), including a conventional telephone, a fax machine, a cellular telephone, a pager, a web-enabled cellular telephone, a portable digital assistant, a pocket PC, or any similar device. In the example described below, communication module 24 is a conventional cellular telephone with text messaging capabilities.

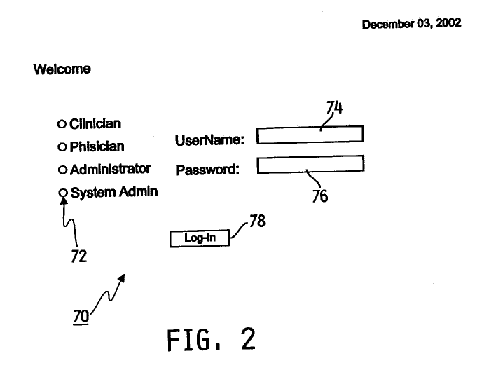

In operation, a clinician or other user of first computing device 14 logs in to system 10 by activating web browser software stored in memory 40 of first computing device 14 and connecting to network 20 in a conventional manner. The clinician accesses the website operated by server 18 by entering the appropriate web address or otherwise executing a script file stored in memory 40 to automatically access the website. Server 18 then generates a log in page 70 as shown in FIG. 2. Any of four different categories of users may log-in by selecting an appropriate radio button 72, entering a user name in field 74, entering a password in field 76, and activating log-in button 78. The user identification and password feature ensures controlled access and secure storage of the testing information in database 64.

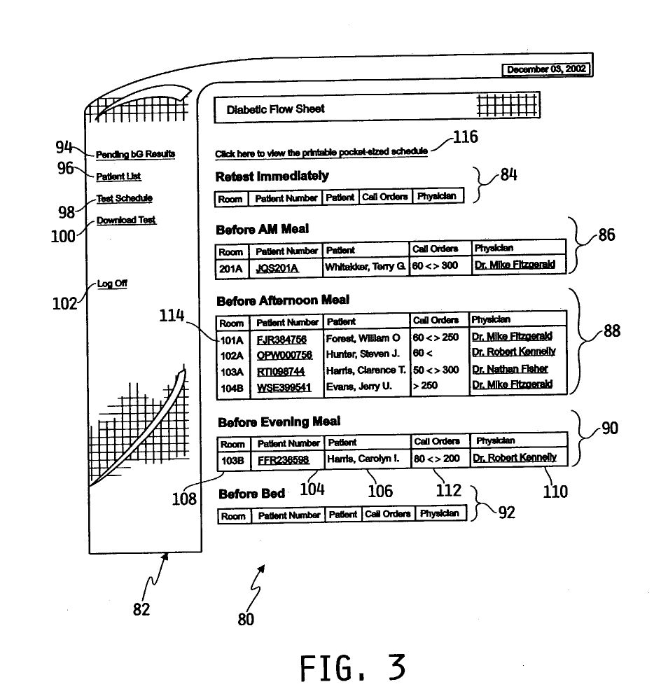

After the above-described log in procedure is completed, server 18 generates a test schedule view page 80 for display on display 36 of first computing device 14 as shown in FIG. 3. Page 80 generally includes a link area 82 and five schedule information areas 84, 86, 88, 90, 92. Link area 68 includes a pending bG results link 94, a patient list link 96, a test schedule link 98, a download test link 100, and a log-off link 102. As further described below, activation of any of links 94, 96, 98, 100, 102 causes server 18 to generate a different page to enable the clinician to accomplish different tasks. Schedule information areas 84, 86, 88, 90, 92 are arranged in chronological order from the top of page 80 to the bottom. Thus, retest immediately area 84 includes information regarding patients who are scheduled for a bG test as soon as possible. Before AM meal area 86, before afternoon meal area 88, before evening meal area 90, and before bed area 92 include similar information. All information areas 84, 86, 88, 90, 92 include similar information (if at least one patient is scheduled for a test during the time corresponding to the particular area). Each area 84, 86, 88, 90, 92 is arranged in a tabular format of rows and columns wherein each column contains a different type of information relating to patients, and each row contains individual items of the different types of information that relate to a particular patient. More specifically, each area 84, 86, 88, 90, 92 includes a patient number column 104 including identification numbers respectively associated with a plurality of patients having testing information stored in database 64, a patient name column 106 including patient names corresponding to the respective patient identification numbers, a room column 108 including designations of room locations of the respective patients, a physician column 110 including names of physicians responsible for reviewing the testing information associated with the respective patients, and a call orders column 112 including predefined bG data threshold values as further described below. For example, row 114 of area 88 indicates that William O. Forest (column 106) having a patient identification number of “FJR384756” (column 104) is located in room 101A (column 108), and is scheduled to have a bG test taken before his afternoon meal, the results of which should fall between 60 and 250 mg/dL (column 112) and must be reviewed by Dr. Mike Fitzgerald (column 110).

Upon review of page 80, the clinician can, for example, at the beginning of a work shift, quickly identify the patients in need of immediate testing, and plan a round of testing information collection accordingly. Additionally, by activating link 116, the clinician can obtain a pocket-sized printout of page 80 to carry for reference during the round of testing. As shown in FIG. 3, no standing orders for tests are indicated by system 10. Instead, only instructions for the next test to be performed on a particular patient are displayed on page 80. It should be understood, however, that page 80 may readily be modified to display, for example, the anticipated or expected testing schedule for each patient for the next twenty-four hour period, or any other predetermined time frame. Such anticipated testing schedule could be based on the patient's past testing regimen, but would typically be displayed only as a time management aid for the clinician. At least in the context of bG tests to be submitted to a government entity for reimbursement under Medicare regulations, each scheduled test displayed on page 80 would have to be updated with actual (as opposed to anticipated) instructions actually received from the treating physician after review of the previous test data.

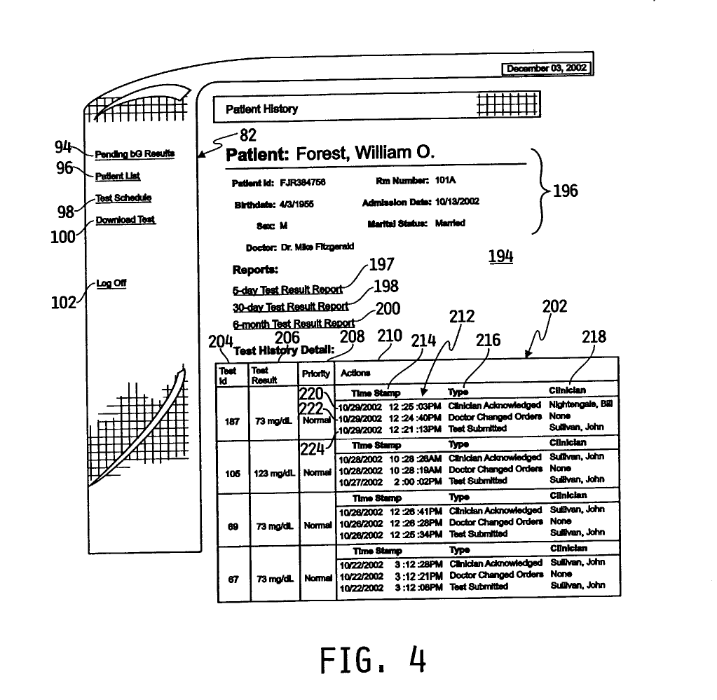

The clinician may access further details regarding any patient's testing information history by activating the patient's identification number in patient number column 104. Upon activating the number (configured as a link to information stored in database 64), server 18 accesses database 64 and generates on display 36 of first computing device 14 a patient history page 194 (or series of pages) containing various types of information relating to the selected patient as shown in FIG. 4. Page 194 includes link area 82 that is identical to link area 82 of page 80. Page 194 further includes a general information area 196 that displays the patient's name, identification number, room number, birth date, admission date, sex, marital status, and responsible physician as reflected by data stored in database 64.

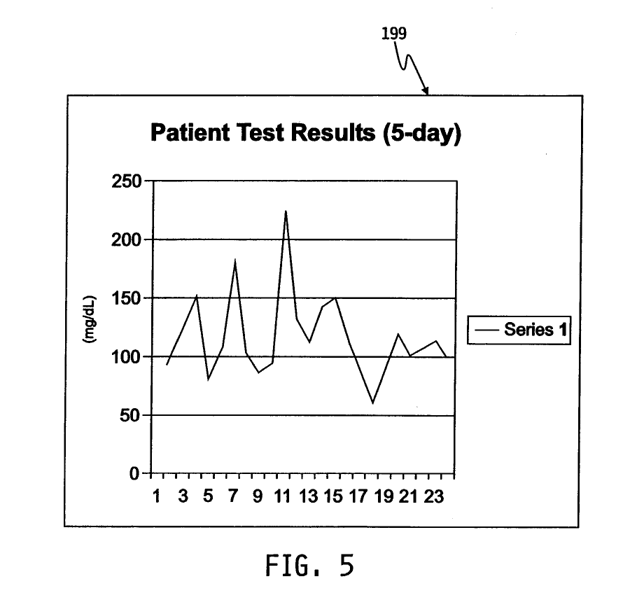

Page 194 also includes a plurality of report links including a 5-day report link 197, a 30-day report link 198, and a 6-month report link 200. Upon activation of any one of links 197, 198, 200, server 18 accesses bG data stored in database 64 corresponding to the selected patient to generate a graphic representation of testing results over a prior time period corresponding to the selected link 197, 198, 200. For example, upon activation of 5-day report link 197, server 18 accesses database 64 to obtain bG testing results for all tests performed (and documented using system 10) on William O. Forest for the five-day period preceding the current date. Server 18 then processes the data to generate a graph 199 as shown in FIG. 5 to facilitate analysis of the data. In addition to presenting a graphical representation of raw data collected over the selected time period, graph 199 may provide bG trend and summary information according to any of a variety of standard formats that are well known in the art. Alternatively, the graphs generated by links 197, 198, 200 may be customized to provide only certain types of information, or provide standard information in a customized format.

Finally, page 194 also includes a test history detail area 202 containing information describing all tests performed on the selected patient and stored in database 64. Area 202 includes a test ID column 204 including a reference number corresponding to each test performed on the selected patient, a results column 206 including the bG data actually measured during the corresponding test (in standard units of mg/dL), a priority column 208 indicating the level of urgency associated with the corresponding test as will be further described below, and an actions column 210 including a plurality of records areas 212, each including records of actions associated with the corresponding test.

As shown in FIG. 4, records area 212 includes a time stamp column 214, a type column 216, and a clinician column 218. The rows of records area 212 correspond to a particular action taken with respect to the test associated with records area 212. As shown, the third row 224 of records area 212 indicates the date and time (in time stamp column 214) the test data of results column 206 was submitted for review (type column 216), a procedure described in detail below, and the name (clinician column 218) of the clinician who performed the test. The middle row 222 of records area 212 similarly indicates the date and time the physician verified his or her review of the data and provided instructions for a subsequent test or other modification to the patient's treatment, another procedure described in detail below. The first row 220 similarly indicates the date and time the clinician acknowledged the physician's verification and instructions, also described in detail below. It should be noted that column 218 of row 220 also identifies the clinician who acknowledged the verification and instructions. Other rows may be added as optional data capture fields for each of columns 214, 216, 218.

As should be apparent from FIG. 4, the clinician may obtain a full history of the testing information associated with the selected patient by scrolling though pages similar to page 194 of FIG. 4. Since the information is presented in reverse chronological order with the most recent test at the top, by scrolling to the last test data entry in history detail area 202, the clinician can view the results of the first test performed on the selected patient. The testing information detail presented on page 194 enables the clinician to determine, for example, why a subsequent testing instruction displayed in retest immediately area 84 (FIG. 3) was generated. Such immediate re-testing instructions may be provided by the treating physician in the event the data from the previous test were abnormal (i.e., out of an acceptable range or otherwise indicating that the patient's bG level is potentially out of control).

After reviewing the test schedule of page 80 (FIG. 3) and seeing the instructions, for example, to test William O. Forest before his afternoon meal, the clinician should obtain device 12 (e.g., a bG meter as described above) and go to room 101A (assuming it is the time of day for taking pre-lunch test data). Upon locating the patient, the clinician uses reader 26 of device 12 to scan patient identification information from tag 30 associated with the patient. The clinician also scans his or her identification tag 28 to provide clinician identification information to device 12. Next, the clinician obtains a blood sample from the patient and uses device 12 and any other required supplies (e.g., a test strip, etc.) to perform a conventional bG test. Device 12 calculates the bG data associated with the test and temporarily stores the data, in association with the patient and clinician identification information, for later transfer to first computing device 14 as described below. It should be understood that, with the appropriate device 12, the clinician may continue throughout the facility and test multiple patients, each time storing the related information in device 12. It should further be noted that the clinician is not required to manually record any information relating to the test(s).

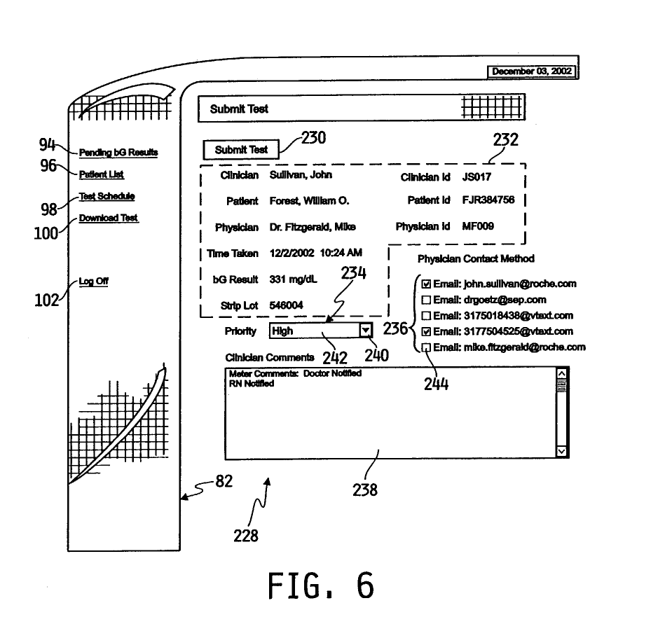

After the test(s) are completed, the clinician couples device 12 to docking station 32 and activates download test link 100 of link area 82. This causes first computing device 14 to issue commands to docking station 32 that facilitate the transfer of the data stored in device 12 from device 12, through docking station 32, to first computing device 14. This data is then temporarily stored in memory 40 of first computing device 14. Simultaneously, first computing device 14 communicates with server 18 via network 20 to indicate that an uploading procedure has been initiated by the clinician. Server 18 then generates a submit test page 228 on display 36 of first computing device 14 as shown in FIG. 6.

Submit test page 228 includes link area 82 (identical to link area 82 of pages 80 and 194), a submit test button or icon 230, a general information area 232, a priority selection box 234, a plurality of contact method options generally referred to by the numeral 236, and a comments area 238. General information area 232 is populated with information received from device 12 via docking station 32 that corresponds to the first test data downloaded from device 12, and information retrieved from database 64. More specifically, when download test link 100 is activated, first computing device 14 receives patient identification information from docking station 32 and transmits that information to server 18. Server 18 then retrieves from database 64 information relating to the physician responsible for the corresponding patient, and sends that information to first computing device 14 via network 20. This information includes physician ID, physician name, and any preferred contact information relating to the responsible physician as shown in general information area 232. The clinician and patient name information (as shown in general information area 232) is retrieved from database 64 in a similar manner based on the clinician and patient identification numbers received by first computing device 14. The clinician ID, patient ID, date and time, bG results, and strip lot information are populated by first computing device 14 based on the information received by first computing device 14 from docking station 32.

It should be understood that where multiple tests are collected by the clinician and simultaneously downloaded via docking station 32 to first computing device 14, system 10 generates multiple versions of page 228 as described above, each version corresponding to a different downloaded test. Each time a clinician activates submit test button 230 (as described below), a new version of page 228 corresponding to the next test to be processed is generated on display 36 of first computing device 14. Alternatively, a summary page (not shown) may be generated on display 36 when multiple tests are downloaded simultaneously. More specifically, a page displaying, for example, the names and test results of the patients corresponding to the downloaded tests may be displayed on one page. Additionally, the screen may include multiple submit test buttons 230 corresponding to the multiple test results displayed. If the clinician determines that a test result is within a safe, in-control, or normal range, then the clinician may activate the submit test button 230 associated with that test result, thereby bypassing some of the steps described below. Moreover, if the clinician desires further information regarding a particular test displayed on such a summary screen, the clinician may activate the patient's name (or similar link) to access the additional details associated with the test such as those provided on screen 228 of FIG. 6.

Priority selection box 234 includes a pull-down button 240 and a priority display area 242. By activating pull-down button 240, the clinician causes first computing device 14 to display a menu of selectable priority levels (not shown) to assign to the test data being uploaded to server 18. For example, if the clinician determines that the bG data indicates a need for immediate or expedited review, then the clinician may select a “high” priority level to associate with the data. Alternatively, the level of priority may be determined by first computing device 14 (or server 18) based on predetermined thresholds or algorithms for analyzing the data. The level of priority selected, either manually or automatically, in priority selection box 234 may cause server 18 to display different contact method options 236 on page 228. For example, a “low” priority selection may cause server 18 to display an email contact method option 236 for communicating a message (as further described below) to the responsible physician that test data has been uploaded to server 18 for review. As shown in FIG. 6, multiple contact method options 236 may be simultaneously available, each of which is selectable by activating a check box 244. In this way, a message may be forwarded to a distribution list of recipients (e.g., the physician's assistant, the physician's home email address, etc.). Alternatively, various methods of communicating the message(s) may be presented as contact method options 236, as further described below. Finally, comments area 238 enables the clinician to enter comments and/or notes that will be included in the message sent to the responsible physician.

It should be further understood that the predetermined thresholds for assigning a priority level to test data may be configured for a specific patient by the patient's treating physician. Additionally, the contact methods for the physician may be customized by the physician such that notifications regarding data having one priority level are communicated according to a first method, and notifications regarding data having a different priority level are communicated according to a second method. Moreover, the notification procedure itself may include an escalation protocol, either customized for each physician or generally applied to all physicians. For example, a notification of data having a low priority may be first sent to the physician by email. System 10 may be configured to begin counting elapsed time upon transmission of the email notification. If a response to the notification is not received within a predetermined time period, then system 10 may cause server 18 to automatically transmit via network 22 a message to communication module 24 associated with the physician (e.g., the physician's pager). If, after another predetermined time period, a response to the message is not received, then server 18 may automatically transmit a message to a communication module 24 associated with a back-up physician. Finally, if after all other predetermined methods of communication have failed to evoke a response, server 18 may transmit a message to first computing device 14 indicating that the clinician, the LTC medical director, or the LTC administrator must take further action to obtain physician review of the test data.

It should be further understood that the communication methods associated with each step in the above-described escalation protocol may vary depending upon the initial priority level. For example, a low priority test result may have four or five levels of escalation, each having relatively long “wait” periods, before LTC personnel are notified of their responsibility to obtain review without the assistance of system 10. A high priority test result may have just two levels of escalation, each having relatively short “wait” periods, before responsibility is shifted to LTC personnel. Additionally, in one embodiment of the invention, a clinician may manually override a priority level determined using predetermined thresholds or algorithms, but only if the override results in an increased priority level. In other embodiments, system 10 may be configured such that clinicians, medical directors, administrators, etc. may manually increase or decrease an automatically determined priority level if such rights have been assigned to the individual, and a user ID/password security procedure is properly executed.

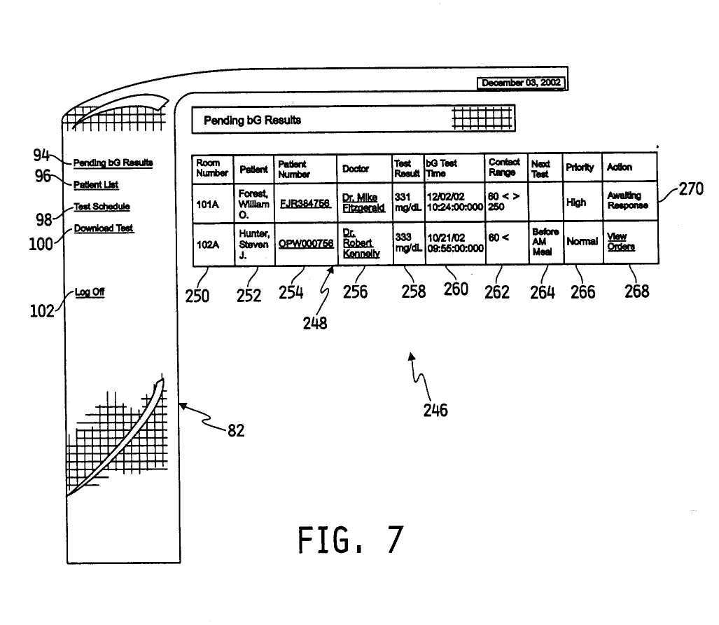

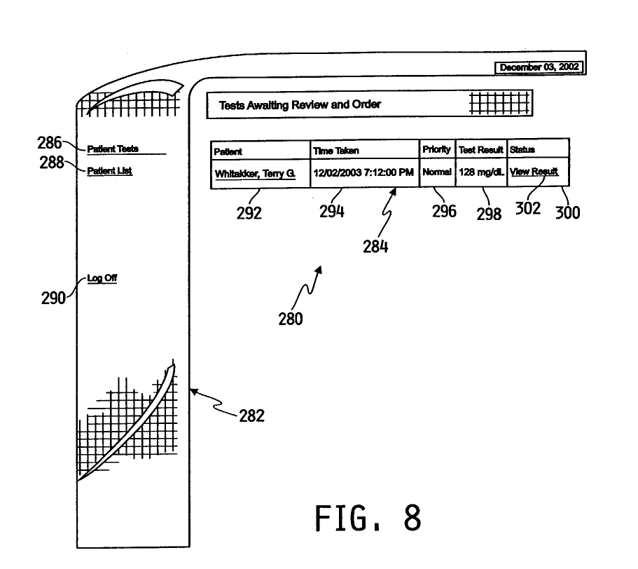

Several actions occur when the clinician activates submit test button 230 of FIG. 6. Server 18 updates database 64 with the information displayed on page 228. A file in database 64 represented by patient history page 194 (FIG. 4) is updated to include the submitted data along with the other associated information as described above. Additionally, the information is added to a file in database 64 represented by a pending results page 246 as shown in FIG. 7 and further described below, and a tests awaiting review and order page 280 as shown in FIG. 8 and further described below. Finally, according to one embodiment of the invention, first computing device 14 processes the information to generate a message for transmission to communication module 24. For example, communication module 24 may receive a text message from server 18 via network 22. The text message may indicate to the physician associated with communication module 24 that bG data is stored in database 64 and awaiting the physician's review. It should be understood that in other embodiments, the message itself may include the bG data, along with a message prompting the physician to verify review of the data by logging in to the website operated by server 18 as described below.

It should be further understood that server 18 may also send an email message via network 20 to second computing device 16 that contains the same information. The email message may also include a link to the website operated by server 18 to simplify the physician's access to the data. Alternatively, first computing device 14 may use the information from page 228 to compose a voice mail message using known technology. First computing device 14 may the use communications device 42 to call a predetermined telephone number associated with the physician and automatically leave the voice mail message requesting the physician to review the uploaded bG data. In yet another alternative embodiment, communications device 42 may similarly contact a predetermined fax machine and transmit a text message to the physician with the same request. Of course, any combination of the above-described message transmission alternatives, as well as any other similar alternatives, are well within the ability of one of ordinary skill in the art.

Referring now to FIG. 7, when the clinician desires to view the status of uploaded tests and activates pending bG results link 94, the clinician is presented with pending results page 246. Page 246 includes link area 82, which is identical to the above-described link area 82, and pending tests area 248. Pending tests area 248 includes a plurality of rows of information (only two shown in FIG. 7), each corresponding to testing information for a particular patient that has been uploaded for review. As shown, each row of information includes fields from a plurality of columns of different types of information. Specifically, pending tests area 248 includes a room number column 250, a patient name column 252, a patient number column 254, a physician name column 256, a test result column 258 including the measured bG data of the most recently uploaded, a test time column 260 including the date and time the test was performed, a contact range column 262 including preset threshold bG ranges used to determine a priority level for the test (e.g., high priority if the bG data is outside the displayed range) and a corresponding escalation protocol, a next test column 264 indicating the time of the next test ordered by the physician (if the data of the previous test has been reviewed), a priority column 266 that indicates the priority level that was either automatically or manually assigned to the bG data, and an action column 268 indicating whether the submitted test data has been reviewed (i.e., includes a view orders link) or remains pending (indicated by an “awaiting response” message).

Referring now to FIG. 8, when the physician responds to any of the above-described messages to review the updated data, and uses second computer 16 to log-in to the website operated by server 18 (via log-in page 70 of FIG. 2), the physician is presented with tests awaiting review and order page 280. Test awaiting review and order page 280 generally include a link area 282 and an information area 284. Link area 282 includes a patient tests link 286, a patient list link 288, and a log-off link 290. Activation of patient test link 286 causes server 18 to generate page 280 shown in FIG. 8. Activation of patient list link 288 causes server 18 to generate a summary listing (not shown) of all patients presently under the care of the physician who logged into system 10. Log-off link 290 enables the physician to log-off of system 10 in a conventional manner. Information area 284 generally includes summary information regarding test data that has been uploaded to server 18, but not reviewed by the treating physician. More specifically, area 284 includes a patient column 292 that indicates the patient's name, a time taken column 294 that provides the date and time the uploaded test data was taken, a priority column 296 that indicates the priority associated with the data, a test result column 298 that includes the actual results of the test in standard units of mg/dL, and a status column 300 that includes a view results link 302. By activating the patient's name in column 292, the physician causes server 18 to generate patient history page 194 (FIG. 4) to enable the physician to review the patient's testing history, graphical reports, etc. as described above.

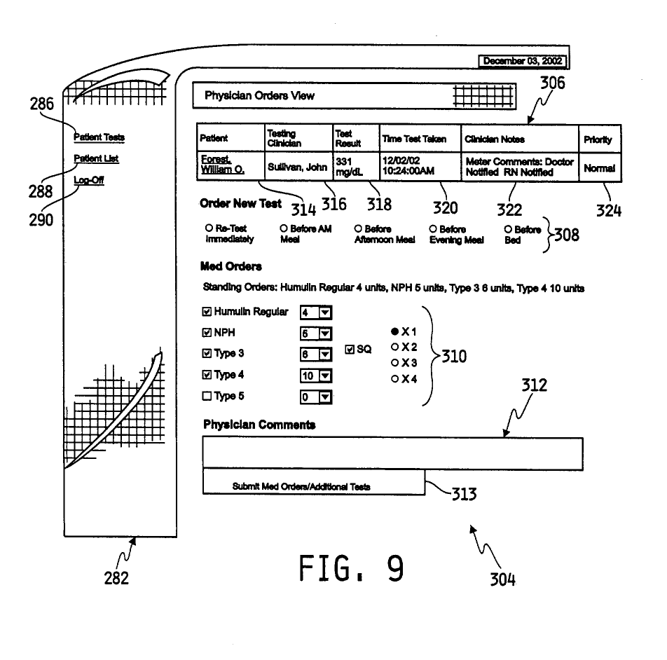

After reviewing the summary information included in information area 284, the physician may verify his or her review of the data and provide instructions for the next test to be performed on the patient by activating, for example, view result link 302, the patient name in column 292, or some other link. Upon such activation, server 18 generates physician order page 304 as shown in FIG. 9 on display 46 of second computing device 16. Page 304 generally includes link area 282 (as described above), a testing information area 306, a plurality of test instruction radio buttons generally referred to by the numeral 308, a dosage modification area 310, a physician's comments box 312, and a submit orders button 313.

Testing information area 306 of page 304 provides a summary of the testing information reviewed by the physician. Area 306 includes a patient name field 314, a clinician name field 316, a test results field 318, a test time field 320, a clinician notes field 322 that includes the message (if any) entered by the clinician into comments area 238 of submit test page 228 (FIG. 6), and a priority field 234 that includes the priority level associated with the test data.

As discussed above, for LTC reimbursement under the Medicare Part B processing requirements, a physician reviewing testing data must not only verify that the data was reviewed, but must also provide instructions for a subsequent test and/or modification to the patient's treatment regimen. Accordingly, server 18 does not respond to any activation of submit orders button 313 until one of radio buttons 308 has been selected by the physician. As shown, except for the re-test immediately button, each of the radio buttons 308 corresponds to a standard testing time for diabetes management. It should be understood, however, that the physician may provide more specific instructions regarding the next test by adding comments in comments box 312.

Dosage modification area 310 includes a plurality of check boxes, pull-down menus, and radio buttons. Each check box corresponds to a common type of insulin that may be included in the patient's regimen. Each pull-down menu permits the physician to order a number of units of the corresponding insulin type for injection as part of the regimen according to well-established practices in the field of diabetes management. The multiplier radio buttons in dosage modification area 168 permit the physician to further modify the dosing orders for the patient according to principles that are well known in the art. Finally, after the physician reviews the uploaded data, makes any desired modifications to the dosing instructions for the patient, enters any comments, and selects a next test time, the physician may activate submit orders button 313.

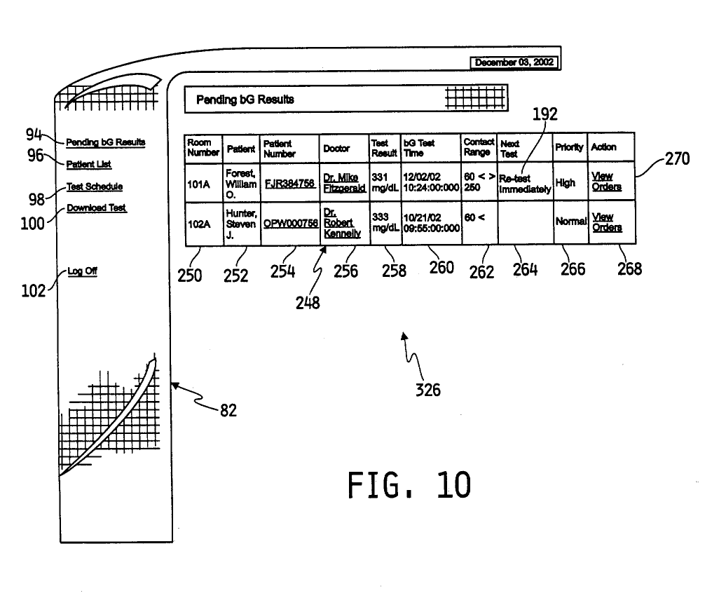

Several actions occur upon activation of submit orders button 313. Server 18 updates the file containing testing information pending review by a physician (for use in generating page 280 of FIG. 8) to remove the testing information corresponding to this most recently reviewed test. Consequently, if the physician again accesses tests awaiting review and order page 280 (FIG. 8), the row of information relating to the most recently reviewed test will not be included. Additionally, server 18 automatically updates the file representing the test history of the appropriate patient. More specifically, server 18 generates a row of information (such as row 222) in records area 212 of patient history page 194 corresponding to the most recently uploaded and reviewed testing information for the patient. The row of information indicates the date and time the physician activated submit orders button 313 (thereby verifying review of the uploaded data and sending subsequent testing instructions), the fact that the physician changed the orders for testing (i.e., provided new testing instructions). Finally, server 18 automatically updates page 326 of FIG. 10 (described below). After submitting verification of review of the testing information and instructions for a subsequent test as described above, the physician may log off by activating log off link 290 of link area 282.

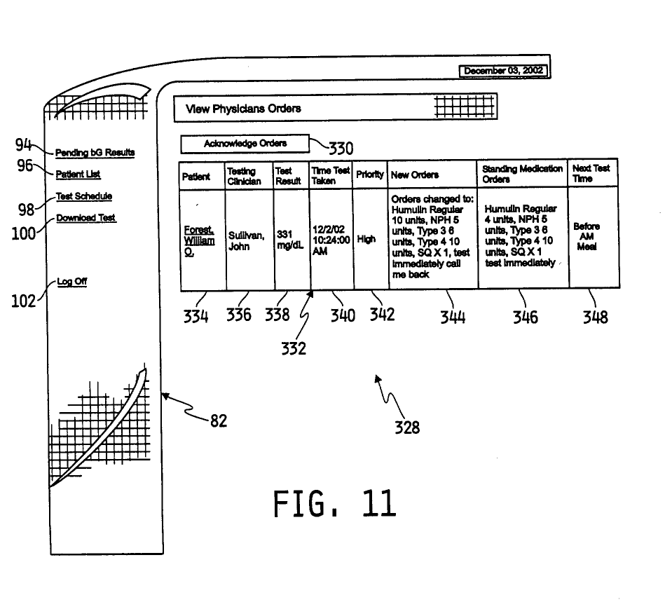

Referring now to FIG. 10, a clinician accessing the website operated by server 18 may view pending results page 326, which is similar to pending results page 246 of FIG. 7 and therefore uses the same reference designations. Page 326 indicates in field 192 that next test instructions have been received from the physician responsible for review of test data for William 0. Forest. The clinician may then access view orders screen 328 of FIG. 11 by, for example, activating the view orders link in row 270 (column 268), or some other link.

As shown in FIG. 11, view orders screen 328 includes link area 82, which is identical to link area 82 described above, an acknowledge order button 330, and an order information area 332. Order information area 332 includes a patient name field 334, a testing clinician field 336, a test result field 338, a test time taken field 340, a priority field 342, a new orders field 344, a standing medication orders field 346, and a next test time field 348. Fields 334, 336, 338, 340, and 342 are populated with information submitted by the clinician using submit test page 228 of FIG. 6. This information corresponds to the uploaded, reviewed, and verified testing information. Field 344 includes information entered by the physician using physician order page 304 of FIG. 9. As shown, field 344 reflects any changes to the patient's dosing regimen resulting from the physician's selections in dosage modifications area 310 of page 304. Additionally, any comments entered by the physician in comments box 312 of page 304 are reflected in field 344. Standing medication orders field 346 includes the normal medication regimen for the patient. Finally, next test time field 348 indicates the time of the next test ordered by the physician. After reviewing the physician's orders shown in FIG. 11, the clinician must activate acknowledge order button 330 before any additional testing information for the patient can be uploaded to server 18.

Several actions occur upon activation of acknowledge order button 330. Specifically, server 18 updates the file containing testing information included in patient history page 194 of FIG. 4. More particularly, records area 212 is updated in the manner described above with regard to the uploading step and the data review verification step to indicate that the physician's new testing instructions have been acknowledged. Additionally, server 18 updates the file including testing information for display on test schedule view page 80 of FIG. 3 and eliminates the information relating to the acknowledged test from the file for display on pending results page 326 of FIG. 10.

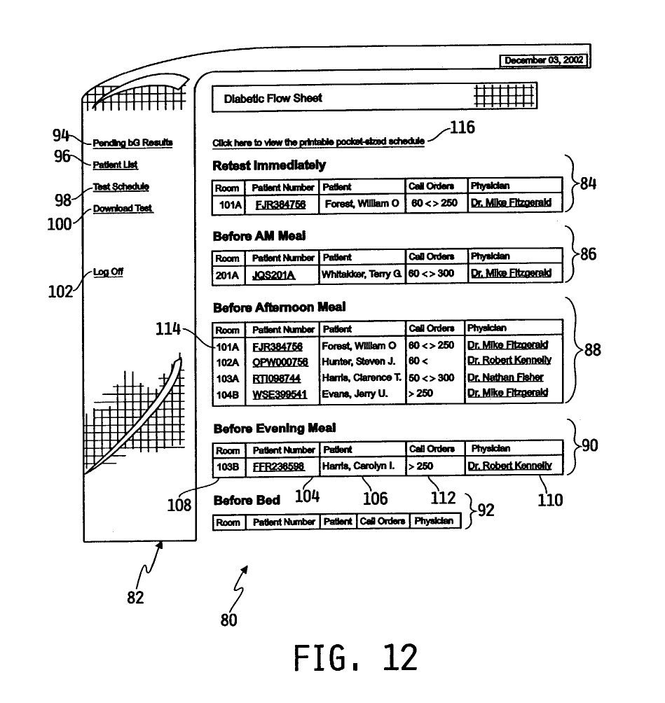

As shown in FIG. 12, when the clinician accesses test schedule view page 80 (previously shown in FIG. 3), page 80 is updated with the most recent test scheduling information provided by the physician upon activation of submit orders button 313 of FIG. 9. Specifically, retest immediately area 84 indicates that William O. Forest should be tested immediately as specified by the physician by selecting the appropriate radio button 308 of page 304 (FIG. 9).

As should be apparent from the foregoing, system 10 provides, among other things, electronic documentation of each step in the testing information management process contemplated by the present invention. In addition to storing time stamped entries of test data uploading, review verification, and acknowledgement in the appropriate locations in database 64 for inclusion in patient history page 194 (FIG. 4), server 18 also maintains a file documenting these steps for each test in a file for submission to the government entity responsible for issuing reimbursements under Medicare Part B to facilities performing such testing. This electronic file is maintained in database 64 for auditing purposes and to populate Medicare reimbursement forms as described below.

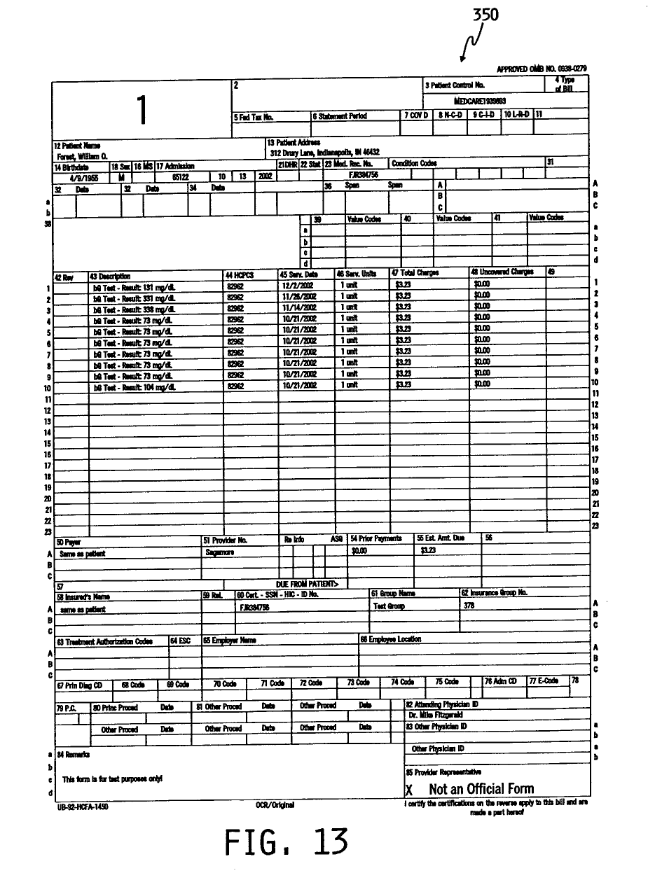

FIG. 13 depicts a Medicare reimbursement form 350 generated by the software stored in memory 40 of first computing device 14. Of course, form 350 may alternatively be generated by software stored in memory 60 of server 18. An administrator of the LTC or some other person responsible for obtaining government reimbursements may access form 350 using first computing device 14 to review completed, fully documented tests that have accumulated since the last submission for reimbursement. As testing information is added by server 18 to the audit file described above, server 18 also updates a reimbursement file containing the appropriate information included on form 350 for reimbursement. Accordingly, any test included on form 350 and submitted for reimbursement will have associated with it in the audit file, full documentation of the upload, review, and acknowledge processes described above. By activating menu selections (not shown) displayed on display 36 of first computing device 14, the administrator may electronically submit form 350, for example via network 20, to a computing device associated with the government entity responsible for fulfilling reimbursement requests. Alternatively, the administrator may print form 350 and submit the form by fax or regular mail for processing by the reimbursement entity.

Finally, it should be understood that server 18 may be maintained and operated by a service provider. Server 18 may maintain database 64 such that documentation of the above-described process is stored for a plurality of different healthcare facilities. The documentation for each facility may be segregated in database 64 such that server 18 can monitor usage of system 10 by the various facilities. Thus, each time testing information is acknowledged by a clinician, indicating that the above-described upload, review, and acknowledge process is complete for a particular test, server 18 may increment a counter associated with the corresponding facility. Server 18 may readily be configured to periodically generate a report for each facility indicating the number of tests processed by the service provider for that facility by accessing the counter associated with the facility. In this manner, each facility may be billed based on the facility's actual usage of system 10. In exchange for providing the service enabled by system 10, facilities may be charged, for example, a percentage of the reimbursed amounts received by the facility.

According to another embodiment of the invention, system 10 of FIG. 1 is configured to facilitate reporting and documentation of incidents as opposed to physiological testing results. Otherwise, the components of this alternative embodiment may be the same as those shown in FIG. 1.

In operation, a clinician responsible for reporting an incident accesses the website operated by server 18 using first computing device 14. The clinician then logs in to system 10 using log in page 70 of FIG. 2 in the manner described above. After log in, the clinician selects from a list of patients the name of the patient to which the incident relates. Server 18 responds to this selection by generating a page on display 36 of first computing device 14 that is similar to page 228 of FIG. 6. This incident report page may include a general information area including the patient ID, treating physician name and ID, and clinician name. The incident report page further includes a plurality of pull-down menus permitting selection of standard incident characteristics (e.g., location of incident, type of incident, type of injury, location of injury on the patient's body, the patient vital signs, medical treatment given to the patient, etc.). Also like page 228 of FIG. 6, the incident report page includes a priority selection box and physician contact method options which function in the manner described above. Additionally, the page includes a text box to enable the clinician to enter further information describing the incident.

In another variation of the present invention, the clinician obtains or collects incident report information away from first computing device 14 and transfers the information to first computing device 14. For example, the clinician may carry medical device 12 to a patient's room after the patient has an accident. The clinician may use reader 26 to scan the patient's identification information and the clinician's identification information as described above. Medical device 12 may be a personal digital assistant or similar device that permits the clinician to enter information describing the incident for temporary storage in medical device 12. The clinician may then use docking station 32 in the manner described above to transfer the incident information to first computing device 14.

By activating a submit incident button (similar to submit test button 230 of FIG. 6), the clinician causes server 18 to send a notification or message to the responsible physician employing any of the methods described above. It should be understood that the above-described procedures relating to priority levels and escalation protocols are also employed in this embodiment of the invention. Activation of the submit incident button also causes server 18 to update an incident history file stored in database 64 in association with the patient. The incident history file may be used by server 18 to generate a patient incident history page similar to page 194 of FIG. 4. Each time an incident is uploaded to server 18, a time-stamped entry is added to the incident history file indicating, for example, the type of incident and the name of the clinician who reported the incident. Finally, a file corresponding to a pending incidents page (similar to page 246 of FIG. 7) is updated with the incident information. Specifically, if after submitting the incident report, the clinician activates a pending incidents link in a link area similar to area 82 of FIG. 6, then server 18 generates the pending incidents page that summarizes the incident details, and indicates the incident report status (e.g., awaiting response).

When the physician receives the notification or message from server 18 indicating that an incident has been uploaded for review, the physician logs in to system 10 in the manner described above. Server 18 then generates a page on display 46 of second computing device 16 similar to page 280 of FIG. 8. Here, the physician is presented with, for example, the patient name, the date and time the incident was uploaded, a brief summary of the type of incident, the priority level of the incident, and a link that permits the physician to view the details of the incident.

When the physician activates the view incident details link, server 18 generates an incident response page similar to page 304 of FIG. 9. The incident response page includes a full description of the incident as reported by the clinician, including any notes or messages. The incident response page further includes a plurality of pull-down menus that permit the physician to select from a plurality of standard response instructions (e.g., contact an ambulance immediately, keep the patient immobilized, administer medication, etc.). Additionally, the incident response page permits the physician to assign a priority to the response instructions and manually enter textual instructions in addition to the standard instruction selections. After the physician has reviewed the incident report and selected and/or entered instructions, the physician activates a submit instructions button similar to submit orders button 313 of FIG. 9.

When the physician activates the submit instruction button, system 10 updates the incident history file (described above) corresponding to the patient to indicate the time and date of the response to the incident, and the pending incidents file (described above) to indicate that the incident report is no longer awaiting a response. Thus, when the clinician next views the pending incidents page (similar to page 326 of FIG. 10), a link (similar to the view orders link in row 270) is presented that permits the clinician to view the physician's instructions for responding to the incident. When the clinician activates this link, server 18 generates a physician's instructions page on display 36 of first computing device 14 similar to page 328 of FIG. 11. The physician's instructions page includes an instructions area that indicates, for example, the patient's name, the priority assigned to the response by the physician, and a full description of the physician's instructions. Additionally, the physician's instructions page includes an acknowledge instructions button similar to acknowledge orders button 330 of FIG. 11.

After the clinician reviews the physician's instructions, the clinician may activate the acknowledge instructions button. Activation of the acknowledge instructions button causes server 18 to update the incident history file (described above) corresponding to the patient to indicate the time and date the instructions were acknowledged, and to remove the incident from the pending incident file (described above). Finally, server 18 updates an incident workflow file that is used to generate an incident workflow page on display 36 of first computing device 14. The incident workflow page is similar to page 80 of FIG. 12, including a schedule of follow-up actions required of the clinicians pursuant to the physician's instructions. The actions may be arranged in order of priority and include links to more detailed descriptions of the physician's instructions and/or the patient's incident history. Finally, each action on the incident workflow page may include a check box to indicate completion of the action. The fact that an action has been completed (as indicated by activation of the associated check box) is reflected in the patient's incident history file (described above), which may be reviewed at any time by the responsible physician.

It should be understood that system 10 is also configured to print a hard copy of any of the pages described above, including the incident history page for inclusion in the corresponding patient's records. Additionally, system 10 maintains a facility log that incorporates all of the incident history files of the patients residing at the facility. This file may be useful for investigation purposes, trend analysis, etc. System 10 may be configured to generate periodic reports (either standard or customized) resulting from this analysis for use in internal care monitoring or for satisfying government survey requests.

It should be further understood that, for a variety of reasons, a clinician may wish to contact a physician directly regarding an incident. In that event, system 10 provides notification redundancy, and serves to documentation each step of the incident reporting, review, response, and acknowledgement. Additionally, system 10 may readily be configured to facilitate notification of family members of the patients by employing the principles described herein. Also, system 10 may readily be configured to print (e.g., on a peel-and-stick label) summaries of the reported incidents, physician instructions, and/or workflow actions. Such labels may be affixed to a patient's physical record, thereby eliminating duplicative data entry. Finally, it should be understood that system 10 may readily be configured to incorporate both the physiological testing embodiment and the incident reporting embodiment in a single, integrated system.

The foregoing description of the invention is illustrative only, and is not intended to limit the scope of the invention to the precise terms set forth. Although the invention has been described in detail with reference to certain illustrative embodiments, variations and modification exist within the scope and spirit of the invention as described and defined in the following claims.

What is claimed is:

1. A method of managing physiological testing information in a healthcare facility including the steps of:
performing a physiological test on a patient;
obtaining data describing a result of the test;
obtaining identification information identifying the patient;
providing the data and the identification information to a computing device at the healthcare facility;
uploading the data and the identification information via a network to a server for storage in a database associated with the server;
updating a first file maintained on the computing device to indicate that the test has a pending status;
sending a message to a person responsible for reviewing the data;
providing the person access via the network to the data stored in the database;
receiving a message from the person indicating that the data was reviewed and including instructions for a next test;
updating the first file to indicate that the test status is no longer pending;
updating a second file maintained on the computing device to include the instructions;
acknowledging receipt of the instructions at the computing device;
generating a time-stamped file in response to the acknowledging step, the time-stamped file including testing information indicating that the test was performed, the data was reviewed, and instructions for another test were received;
incorporating the time-stamped file into a third file maintained on the computing device, the third file being configured for submission to an entity responsible for reimbursing the healthcare facility for a portion of an expense of performing the test;
incorporating the time-stamped file into a fourth file maintained on the computing device to provide documentation of testing information for audit purposes; and
periodically submitting the third file to the entity to obtain reimbursements associated with any time-stamped files included in the third file.

2. The method of claim 1 wherein the performing step includes the step of obtaining a sample of blood from the patient.

3. The method of claim 1 wherein the obtaining data step includes the step of operating a blood glucose meter.

4. The method of claim 1 wherein the obtaining identification information step includes the step of scanning a bar code.

5. The method of claim 1 further including the step of obtaining information identifying a clinician performing the test.

6. The method of claim 1 wherein the providing the data step includes the step of coupling a blood glucose meter to a docking station coupled to the computing device.

7. The method of claim 6 wherein the docking station is configured to receive data from a plurality of different types of blood glucose meters.

8. The method of claim 1 wherein the server includes software configured to generate a first screen on the computing device including a schedule for performing physiological tests on a plurality of patients.

9. The method of claim 8 wherein the schedule includes a listing of a plurality of physicians respectively associated with the plurality of patients.

10. The method of claim 1 wherein the network is the internet.

11. The method of claim 1 wherein the uploading the data step includes the step of selecting a method for sending the message to the person.

12. The method of claim 1 wherein the uploading the data step includes the step of selecting a priority level associated with the message.

13. The method of claim 1 wherein the uploading the data step includes the step of determining a priority level associated with the message according to a predetermined parameter.

14. The method of claim 1 wherein the uploading the data step includes the step of entering comments relating to the data into the computing device for storage in the database and review by the person.

15. The method of claim 1 wherein the uploading the data step is performed by actuating a single button on the computing device.

16. The method of claim 15 wherein the button is an icon displayed on a screen of the computing device.

17. The method of claim 1 wherein the computing device performs the step of updating the first file to indicate the pending status of the test automatically in response to completion of the uploading the data step.

18. The method of claim 1 wherein the sending a message step includes the step of calling a telephone associated with the person.

19. The method of claim 1 wherein the sending a message step includes the step of calling a fax machine associated with the person.

20. The method of claim 1 wherein the sending a message step includes the step of sending an email message to another computing device associated with the person.

21. The method of claim 20 wherein the email message includes the data.

22. The method of claim 20 wherein the email message includes a link to the server to facilitate access to the data.

23. The method of claim 1 wherein the step of providing the person access includes the step of providing a website having a log-in page that permits access to data stored in the database in response to receipt of an authorized user identification and password.

24. The method of claim 23 wherein the website further includes a physician orders page that permits the person to enter the instructions for the next test.

25. The method of claim 1 further including the step of updating a fifth file maintained on the computing device to include the instructions, the fifth file further including instructions for testing a plurality of patients.

26. The method of claim 1 further including the step of updating a sixth file associated with the patient to indicate when the data was uploaded, when the message from the person was received, and when receipt of the instructions was acknowledged.

27. The method of claim 1 wherein the acknowledging step is performed by actuating a button on the computing device.

28. The method of claim 1 wherein the step of incorporating the time-stamped file into the third file is only performed if the step of incorporating the time-stamped file into the fourth file is completed.

29. The method of claim 1 wherein the periodically submitting step includes the step of generating a medicare form on the computing device and populating fields on the form with information in the third file.

30. The method of claim 1 wherein the periodically submitting step includes the steps of printing information from the third file and mailing the printed information to the entity.

31. The method of claim 1 wherein the periodically submitting step includes the step of electronically transferring information from the third file to the entity.

32. The method of claim 1 further including the step of periodically generating a report including a total number of time-stamped files generated over a time period.

33. The method of claim 32 further including the step of billing the healthcare facility an amount for each time-stamped file included in the report.

34. A method for obtaining reimbursement for an expense associated with performing a physiological test, including the steps of:
uploading data resulting from the test to a server;
notifying a person that the test is complete;
receiving a message from the server verifying that the data was reviewed by the person;
acknowledging receipt of the message; and
automatically updating a reimbursement file documenting the uploading, receiving, and acknowledging steps for submission to an entity for reimbursement of the expense.

35. The method of claim 34 further including the step of transferring the data from a blood glucose meter to a first computer using a docking station.

36. The method of claim 35 wherein the docking station is configured to receive data from a plurality of different types of blood glucose meters.

37. The method of claim 34 further including the step of obtaining information identifying the patient and a clinician performing the test.

38. The method of claim 37 wherein the obtaining identification information step includes the step of scanning a bar code.

39. The method of claim 37 further including the step of uploading the identifying information to the server.

40. The method of claim 34 wherein the uploading step includes the step of connecting to a network.

41. The method of claim 34 further including the step of electronically updating a status file to indicate that the data has been uploaded but not reviewed.

42. The method of claim 41 wherein the step of electronically updating the status file is performed automatically in response to completion of the uploading step.

43. The method of claim 41 further including the step of electronically updating the status file to indicate receipt of the message from the server.

44. The method of claim 34 wherein the notifying step includes the step of automatically transmitting over a network a message to an electronic device associated with the person in response to completion of the uploading step.

45. The method of claim 44 wherein the electronic device is one of a conventional telephone, a cellular telephone, a fax machine, a personal digital assistant, and a portable computing device.

46. The method of claim 34 wherein the notifying step includes the step of sending an email message to a computing device associated with the person.

47. The method of claim 46 wherein the email message includes the data.

48. The method of claim 34 further including the step of providing the person access to the data at the server.

49. The method of claim 48 wherein the step of providing the person access includes the step of providing a website having a log-in page that permits access to the data in response to receipt of an authorized user identification and password.

50. The method of claim 49 wherein the website further includes a transmit physician orders page that permits the person to enter instructions for a next test.

51. The method of claim 34 wherein the message from the server includes instructions for a next test.

52. The method of claim 51 further including the step of automatically responding to receipt of the message from the server by electronically updating an orders file to include the instructions.

53. The method of claim 34 wherein the step of automatically updating the reimbursement file is performed in response to completion of the acknowledging step.

54. The method of claim 34 wherein the step of automatically updating the reimbursement file includes the steps of recording a time associated with the uploading, receiving, and acknowledging steps, recording information identifying a patient associated with the test, recording information identifying a clinician who performed the test, and recording information identifying the person who reviewed the test data.

55. The method of claim 34 further including the step of automatically updating an audit file documenting the uploading, receiving, and acknowledging steps.

56. The method of claim 55 wherein the step of automatically updating the reimbursement file is only performed if the step of automatically updating the audit file is completed.

57. The method of claim 34 wherein the uploading step includes the step of selecting a method for notifying the person.

58. The method of claim 34 wherein the uploading step is performed by actuating a single button on a computing device.

59. The method of claim 34 further including the steps of generating a medicare form and populating fields on the form with information in the reimbursement file.

60. The method of claim 34 further including the step of periodically generating a report including a total number of messages acknowledged over a time period.

61. A method of managing physiological testing information including the steps of:
performing a physiological test on a patient using an electronic medical device;
electronically transferring to a computing device testing information including data describing a result of the test and the patient identity;
uploading the testing information via a first network to a server for storage in a database;
updating a status file to indicate that the test is of pending status;
notifying a person via a second network of the pending status of the test;
receiving a message from the person via the first network indicating that the testing information was reviewed and including instructions for another test;
generating a time-stamped file indicating that the test was performed, the testing information was reviewed, and instructions for another test were received; and
submitting the time-stamped file to an entity responsible for reimbursing at least a portion of an expense of performing the test.

62. The method of claim 61 further including the step of providing the person access via the first network to the data stored in the database.

63. The method of claim 61 further including the step of automatically updating an orders file maintained on the server to include the instructions.

64. The method of claim 61 further including the step of acknowledging receipt of the message at the computing device.

65. The method of claim 64 wherein the generating step is automatically performed in response to the acknowledging step.

66. The method of claim 64 further including the step of responding to completion of the acknowledging step by automatically updating an audit file indicating that the test was performed, the testing information was reviewed, and instructions for another test were received.

67. The method of claim 61 wherein the performing step includes the step of obtaining a sample of blood from the patient.

68. The method of claim 61 wherein the data includes blood glucose data.

69. The method of claim 61 wherein the testing information further includes an identity of a clinician performing the test.

70. The method of claim 61 wherein the electronically transferring step includes the step of coupling the electronic medical device to a docking station coupled to the computing device.

71. The method of claim 70 wherein the docking station is configured to receive data from a plurality of different types of electronic medical devices.

72. The method of claim 61 wherein the uploading step includes the step of selecting a method for notifying the person.

73. The method of claim 61 wherein the computing device performs the updating step automatically in response to completion of the uploading step.

74. The method of claim 61 wherein the submitting step includes the step of generating a medicare form on the computing device and populating fields on the form with information in the time-stamped file.

75. A system for managing physiological tests performed in a healthcare facility, including:
an electronic medical device configured to generate data describing results of physiological tests performed on patients;
a docking station configured to receive the data from the device;
a network including a server and a database associated with the server;
a facility computing device coupled between the docking station and the network, the facility computing device configured to receive the data from the docking station and including browser software for transferring the data to the database;
a physician computing device coupled to the network, the physician computing device including browser software for accessing the database via the server; and
a communication device coupled to the facility computing device, the communication device forwarding a notification to a physician in response to the transfer of data to the database;
the server further including application software that maintains a status file indicating whether data from a test has been reviewed by a physician.

76. The system of claim 75 wherein the application software further maintains a completed tests file including a plurality of entries, each entry including information describing the test data, when the test was performed, when the data was reviewed, and who reviewed the data.

77. The system of claim 76 wherein the application software is configured to generate an entry for incorporation into the completed tests file only after the facility computing device receives a message from the physician computing device indicating that the data has been reviewed, and a clinician operating the facility computing device provides input to the facility computing device indicating acknowledgement of receipt of the message.

78. The system of claim 75 wherein the electronic medical device includes an input device configured to receive information identifying the patient and a clinician performing the test.

79. The system of claim 78 wherein the input device is a bar code reader.

80. The system of claim 75 wherein the notification includes a request that the physician review the data.

81. The system of claim 75 wherein the server generates a web page to enable the physician to send a message to the facility computing device indicating that the data was reviewed and including instructions for a next test.

82. The system of claim 81 wherein the facility computing device automatically responds to receipt of the message by updating the status file to indicate that the data has been reviewed.

83. The system of claim 75 wherein the application software further generates a form including a portion of the contents of the completed tests file for submission to an entity responsible for reimbursing the healthcare facility for a portion of an expense of performing the tests.

84. The system of claim 75 wherein the electronic medical device is a blood glucose meter.

85. The system of claim 75 wherein the docking station is configured to receive data from a plurality of different electronic medical devices.

86. The system of claim 75 wherein the application software generates a page that enables a clinician to select a method of forwarding the notification to the physician.

87. The system of claim 75 wherein the application software is configured to automatically update the status file in response to activation of the facility computing device browser software to transfer the data to the database.

88. The system of claim 75 wherein the notification includes the data.

89. A system for obtaining physician review of blood glucose data obtained in a healthcare facility, the system including:
a blood glucose meter;
a first computer located in the healthcare facility, the first computer being configured to receive blood glucose data from the blood glucose meter;
a network including a server coupled to the first computer, the first computer being configured to facilitate physician review of the data by uploading the data to the server and transmitting a message to a physician responsible for reviewing the data; and
a second computer coupled to the network, the second computer being configured to provide access to the data via the server, the second computer including an interface to enable the physician to view the data and transmit instructions for obtaining additional data to the first computer;
wherein the first computer is configured to respond to receipt of the instructions by updating a file that identifies the physician and describes when the data was reviewed.

90. A system for managing physiological tests performed in a healthcare facility, including:
means for generating data describing results of a physiological test performed on a patient;
means for receiving the data from the generating means;
a first computing means coupled to the receiving means for transferring the data;
means for storing the transferred data;
means for accessing the transferred data;
means for coupling the first computing means, the storing means, and the accessing means together;
a second computing means coupled to the coupling means, the second computing means including means for communicating with the accessing means;
means coupled to the first computing means for notifying a healthcare provider of a transfer of data to the storage means; and
means operable by the first computing means for maintaining a file indicating when data from a test has been reviewed by a healthcare provider.

91. A method for managing incident report information in a healthcare facility, including the steps of:
uploading to a server information describing an incident involving a patient;
notifying a person that the information is available for review;
receiving a message from the server verifying that the information was reviewed by the person;
acknowledging receipt of the message; and
automatically updating a history file documenting the uploading, receiving, and acknowledging steps.

92. The method of claim 91 further including the step of obtaining information identifying the patient and a clinician reporting the incident.

93. The method of claim 91 further including the step of electronically updating a pending incidents file to indicate that the information has been uploaded but not reviewed.

94. The method of claim 91 wherein the notifying step includes the step of automatically transmitting over a network a message to an electronic device associated with the person in response to completion of the uploading step.

95. The method of claim 91 further including the step of automatically responding to receipt of the message from the server by electronically updating an instructions file to include instructions from the person reviewing the information.

96. The method of claim 95 further including the step of printing the instructions on a label.

97. The method of claim 91 wherein the uploading step includes the step of selecting a method for notifying the person.

98. The method of claim 91 further including the step of generating a report that provides an analysis of information in the history file.

99. A system for managing information relating to an incident corresponding to a patient in a healthcare facility, including:
a network including a server and a database associated with the server;
a facility computing device coupled to the network, the facility computing device including an input device for permitting entry of the information into the facility computing device and browser software for transferring the information to the database;
a physician computing device coupled to the network, the physician computing device including browser software for accessing the database via the server; and
a communication device coupled to the facility computing device, the communication device forwarding a notification to a physician in response to the transfer of information to the database;
the server further including application software that maintains a file indicating whether the information relating to the incident has been reviewed by the physician.

100. The system of claim 99 further including an electronic medical device configured to receive information identifying the patient and a clinician reporting the incident.
